(19) United States
(12) Patent Application Publication
(10) Pub. No.: US 2024/0210287 A1
(43) Pub. Date: Jun. 27, 2024

(54) PATHOLOGY GROSSING TOOL SYSTEM

(71) Applicant: Loma Linda University, Loma Linda, CA (US)

(72) Inventors: Yahya Daneshbod, Redlands, CA (US); Jeremy Deisch, Yucaipa, CA (US)

(73) Assignee: Loma Linda University, Loma Linda, CA (US)

(21) Appl. No.: 18/571,932

(22) PCT Filed: Jun. 17, 2022
(86) PCT No.: PCT/US2022/034107

§ 371 Date: Dec. 19, 2023

Related U.S. Application Data
(60) Provisional application No. 63/212,206, filed on Jun. 18, 2021.

(51) Int. Cl. G01N 1/28

(52) U.S. Cl. CPC G01N 1/286; G01N 2001/2873

(57) ABSTRACT

A pathology grossing tool having an elevated base having a cutting surface positioned a predetermined height above a bottom surface of the elevated base, and a grossing cap operable to be disposed over at least a portion of the cutting surface, the grossing cap having a sidewalls extending along the predetermined height. A groove formed in the grossing cap operable to expose the cutting surface and a membrane receiving area is formed between the cutting surface and the grossing cap when the grossing cap is operably disposed over at least the portion of the cutting surface.

### CROSS REFERENCE TO RELATED APPLICATION

This application claims the benefit of U.S. Provisional Application No. 63/212,206, filed on Jun. 18, 2021, which is incorporated herein by reference.

### BACKGROUND

### 1. Field of the Invention

The present inventive concept relates generally to pathology samples.

### 2. Description of Related Art

Pathology sample preparation can be difficult due the desire to create multiple samples having a uniform thickness for analysis. This process can be especially difficult with membranes and/or other tissue that often compresses, slides, and/or rolls during tissue processing, thus leaving non-uniform samples.

### SUMMARY

A pathology grossing tool including an elevated base having a cutting surface positioned a predetermined height above a bottom surface of the elevated base, a grossing cap operable to be disposed over at least a portion of the cutting surface, the grossing cap having a sidewalls extending along the predetermined height, a groove formed in the grossing cap operable to expose the cutting surface, and wherein a membrane receiving area is formed between the cutting surface and the grossing cap when the grossing cap is operably disposed over at least the portion of the cutting surface.

The pathology grossing tool in which the cutting surface can have one or more knife slots formed therein. The one or more knife slots can be operable to receive at least a portion of a knife blade therein. The one or more knife slots can align with the groove.

The elevated based can include an alignment block operable to properly align and/or secure the grossing cap. The grossing cap can have a curved upper surface formed between the sidewalls, wherein the membrane receiving area is operably formed between the cutting surface and the curved upper surface.

The grossing cap can have a second groove formed therein. The groove and/or the second groove can have a width of at least 4 millimeters (mm). The groove can have a first width of at least 4 mm and the second groove can have a width of at least 0.5 mm.

A pathology grossing system including a pathology grossing tool having an elevated base and a grossing cap. The pathology grossing tool can include a cutting surface positioned a predetermined height above a bottom surface of the elevated base, a groove formed in the grossing cap operable to expose a portion of the cutting surface, wherein the grossing cap is operable to be disposed over at least a portion of the cutting surface, wherein a membrane receiving area is formed between the cutting surface and the grossing cap when the grossing cap is operably disposed over at least the portion of the cutting surface, and a dual-bladed knife operable to be received within the groove, the dual bladed knife having a predetermined spacing between the two blades.

The cutting surface can have one or more knife slots formed therein, the one or more knife slots operable to receive at least a portion of the dual-bladed knife therein. The one or more knife slots can align with the groove. The elevated based can include an alignment block operable to properly align and/or secure the grossing cap.

The grossing cap can have a curved top surface formed between the sidewalls, wherein the membrane receiving area is formed between the cutting surface and the curved top surface.

The grossing cap can have a second groove formed therein. The groove and/or the second groove can have a width of at least 4 millimeters (mm). The groove can have a first width of at least 4 mm and the second groove can have a width of at least 0.5 mm. The dual-bladed knife can include two blades operably coupled with a knife handle, and the two blades having the predetermined spacing coupled with the knife handle from a blade cartridge.

A method of pathology grossing sample, the method includes preparing a tissue sample, placing the tissue sample on a cutting surface of an elevated base, the elevated base having a predetermined height, securing the tissue sample on the cutting surface by placing a grossing cap over at least a portion of the cutting surface, wherein the grossing cap has sidewalls extending over a portion of the predetermined height, cutting the tissue sample through one or more grooves formed in the grossing cap, and removing a pathology grossing sample through the one or more grooves.

The method can include cutting the tissue sample implementing a dual-bladed knife having a predetermined spacing corresponding to a width of the one or more grooves.

### BRIEF DESCRIPTION OF THE DRAWINGS

The novel features of the disclosure are set forth with particularity in the appended claims. A better understanding of the features and advantages of the present inventive concept will be obtained by reference to the following detailed description that sets forth illustrative examples, in which the principles of the disclosure are utilized, and the accompanying drawings of which:

FIG. 1 is a diagrammatic view of a pathology grossing tool, according to at least one embodiment of the present inventive concept;

FIG. 2 is an isometric view of a pathology grossing tool, according to at least one embodiment of the present inventive concept;

FIG. 3 is an assembled planar view of a pathology grossing tool, according to at least one embodiment of the present inventive concept;

FIG. 4A is an exploded isometric view of a pathology grossing tool system, according to at least one embodiment of the present inventive concept;

FIG. 4B is a side planar view of a pathology grossing tool system, according to at least one embodiment of the present inventive concept;

FIG. 4C is an end planar view of a pathology grossing tool system, according to at least one embodiment of the present inventive concept;

FIG. 5 is an isometric view of a pathology grossing tool system, according to at least one embodiment of the present inventive concept; and

FIG. 6 is a diagrammatic end planar view of a pathology grossing tool system, according to at least one embodiment of the present inventive concept.

### DETAILED DESCRIPTION

Examples and various features and advantageous details thereof are explained more fully with reference to the exemplary, and therefore non-limiting, examples illustrated in the accompanying drawings and detailed in the following description. Descriptions of known starting materials and processes can be omitted so as not to unnecessarily obscure the disclosure in detail. It should be understood, however, that the detailed description and the specific examples, while indicating the preferred examples, are given by way of illustration only and not by way of limitation. Various substitutions, modifications, additions and/or rearrangements within the spirit and/or scope of the underlying inventive concept will become apparent to those skilled in the art from this disclosure.

### I. Terminology

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but can include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term substantially, as used herein, is defined to be essentially conforming to the particular dimension, shape or other word that substantially modifies, such that the component need not be exact. For example, substantially cylindrical means that the object resembles a cylinder, but can have one or more deviations from a true cylinder.

Additionally, any examples or illustrations given herein are not to be regarded in any way as restrictions on, limits to, or express definitions of, any term or terms with which they are utilized. Instead these examples or illustrations are to be regarded as being described with respect to one particular example and as illustrative only. Those of ordinary skill in the art will appreciate that any term or terms with which these examples or illustrations are utilized encompass other examples as well as implementations and adaptations thereof which can or cannot be given therewith or elsewhere in the specification and all such examples are intended to be included within the scope of that term or terms. Language designating such non-limiting examples and illustrations includes, but is not limited to: “for example,” “embodiment,” “for instance,” “e.g.,” “In some examples,” and the like.

Although the terms first, second, etc. can be used herein to describe various elements, components, regions, layers and/or sections, these elements, components, regions, layers and/or sections should not be limited by these terms. These terms are only used to distinguish one element, component, region, layer or section from another. Thus, a first element, component, region, layer or section discussed below could be termed a second element, component, region, layer or section without departing from the teachings of the present inventive concept.

### II. General Architecture

The systems and methods disclosed herein relate to a pathology grossing tool and related system. While the present disclosure issues a pathology grossing tool implemented with respect to a rolled tissue membrane, it is within the scope of the present disclosure to implement the present disclosure with any tissue sample desired for a pathology grossing sample. The tissue sample can be prepared in the desired manner and placed upon a cutting surface of an elevated base. A grossing cap can be placed over the tissue sample and the elevated base, thus securing the tissue sample within a membrane receiving area. The grossing cap can include one or more grooves formed therein exposing a portion of the tissue sample to prepare a pathology grossing sample. A knife or bladed tool can be implemented for cutting the tissue sample against the cutting surface of the elevated base, and the pathology grossing sample can be removed through the one or more grooves on the grossing cap, thus keeping the tissue sample secure throughout the process.

The presently disclosed technology may be implemented in any medical, and/or other related field and can further be implemented with a single or dual bladed knife with respect to cutting the tissue sample. The presently disclosed technology may be implemented to improve pathology through generation of uniform samples.

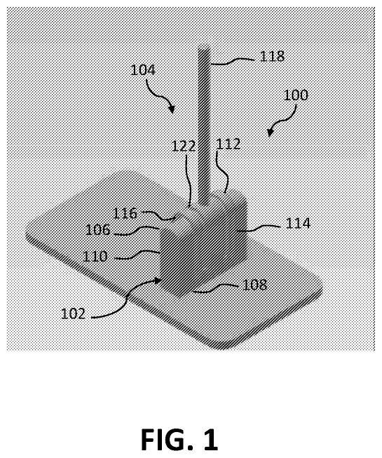

FIG. 1 illustrates an environmental view of a pathology grossing tool, according to at least one instance of the present disclosure. The pathology grossing tool 100 can have an elevated base 102 operable to receive a grossing cap 104 over at least a portion thereof. The elevated base 102 can have a cutting surface 106 formed along a top surface. The cutting surface 106 can elevated from a bottom surface 108 by a predetermined height 110.

The grossing cap 104 can be operable to be disposed over at least a portion of the elevated base such that a top surface 112 of the grossing cap 104 can be disposed over at least a portion of the cutting surface 106, and sidewalls 114 that extend over at least a portion of the predetermined height 110. The grossing cap 104 can have a substantially interference fit when disposed over the elevated base 102, thus allowing easy coupling between the grossing cap 104 and the elevated base 102 while also prevented excessive slop and/or play between the two elements.

The pathology grossing tool 100 can have a membrane receiving area 116 formed between the cutting surface 106 of the elevated base 102 and the top surface 112 of the grossing cap 104. The membrane receiving area 116 can be operable to receive a selection of patient tissue therein in preparation for cutting a tissue sample. In at least one instance, the membrane receiving area 116 can be operable to receive a rolled portion of patient tissue (e.g. placenta membrane).

The grossing cap 104 can include a handle 118 operable to assist in coupling and/or disposing the grossing cap 104 over the elevated base 102. The handle 118 can assist in placing and/or aligning the grossing cap 104 relative to the elevated base 102. The handle 118 can further assist in removing the grossing cap 104 from the elevated base 102 following preparation of a tissue sample.

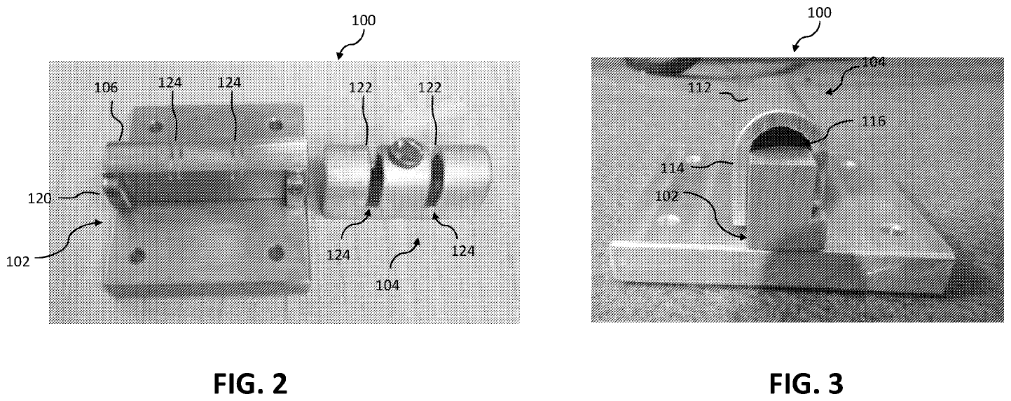

FIG. 2 illustrates a pathology grossing tool having an elevated base decoupled from the grossing cap. The elevated base 102 of the pathology grossing tool 100 can include one or more alignment blocks 120 operable too assist in aligning the coupling of the grossing cap 104 with the elevated base 102. The one or more alignment blocks 120 can position the grossing cap 104 over a predetermined portion of the cutting surface 106 while also insuring the grossing cap 104 is securely coupled with the elevated base 102. The one or more alignment blocks 120 in conjunction with the predetermined height 110 and the sidewalls 114 can collectively couple the grossing cap 104 with the elevated base 102.

The grossing cap 104 can include one or more grooves 122 formed therein operable to expose at least a portion of the cutting surface 106 when the grossing cap 104 is coupled with the elevated base 102. The one or more grooves 122 can be operable to receive a cutting tool therein to produce a tissue sample of a prescribed thickness. The one or more grooves 122 can have a predetermined width 124 defined by the prescribed thickness of tissue sample. In at least one instance, the grossing cap 104 can have two grooves 122 formed therein with a first groove having a first predetermined width and a second groove having a second predetermined width. The one or more grooves 122 can provide access to the cutting surface 106, thereby exposing the tissue within membrane receiving area 116.

The elevated base 102 can include knife slots 124 therein. The knife slots 124 can substantially align with the one or more grooves 122 formed in the grossing cap 104. The knife slots 124 can be operable to receive a portion of a knife blade therein, thus allowing a knife blade to pass completely through tissue within the membrane receiving area 116 and forming a complete tissue sample. As can appreciated in FIG. 2, the cutting surface 106 can a non-flat surface (e.g. curved) corresponding to a shape of the top surface 112 the grossing cap 104. The knife slots 124 can provide a flat termination point to insure the tissue within the membrane receiving area 116 is completely severed across the entirety of the cutting surface 106 without the need for rocking or sawing the knife. In other instances, as detailed below with respect to FIG. 3, the cutting surface 106 can be a substantially flat surface and still include knife slots 124 therein.

The knife slots 124 can correspond to a desired pathology tissue sample. In some instances, the knife slots 124 can be a pair of parallel knife slots corresponding to the width of the groove 122 associated therewith. In instances of a grossing cap 104 having a plurality of grooves 122, the elevated base 102 can implement a plurality of knife slots 124 with a pair of knife slots 124 associated with each of the plurality of grooves 122. As discussed above with respect to the grooves 122, the knife slots can have a predetermined width associated with the corresponding groove 122.

FIG. 3 illustrates a pathology grossing tool having an elevated base coupled with the grossing cap, according to at least one instance of the present disclosure. The pathology grossing tool 100 can have a membrane receiving area 116 formed between the cutting surface 106 and the top surface 112 of the grossing cap 104. The membrane receiving area 116 can be operable to receive a tissue sample therein. The tissue sample can compressed and/or otherwise secured within the membrane receiving area 116 by the cutting surface and/or the top surface 112. In at least one instance, the tissue sample can be a membrane roll (e.g. placenta membrane) operable to force a cross-sectional rolled slice.

As can be appreciated in FIG. 3, the cutting surface 106 can be a substantially planar or slightly concave and the top surface 112 can be a concave curved surface, thus forming the membrane receiving area 116. While FIG. 3 illustrates a flat cutting surface 106 and a curved top surface 112, it is within the scope of the present disclosure to implement a curved cutting surface 106 (as detailed in FIG. 2) with a curved top surface 112, and/or any combination thereof.

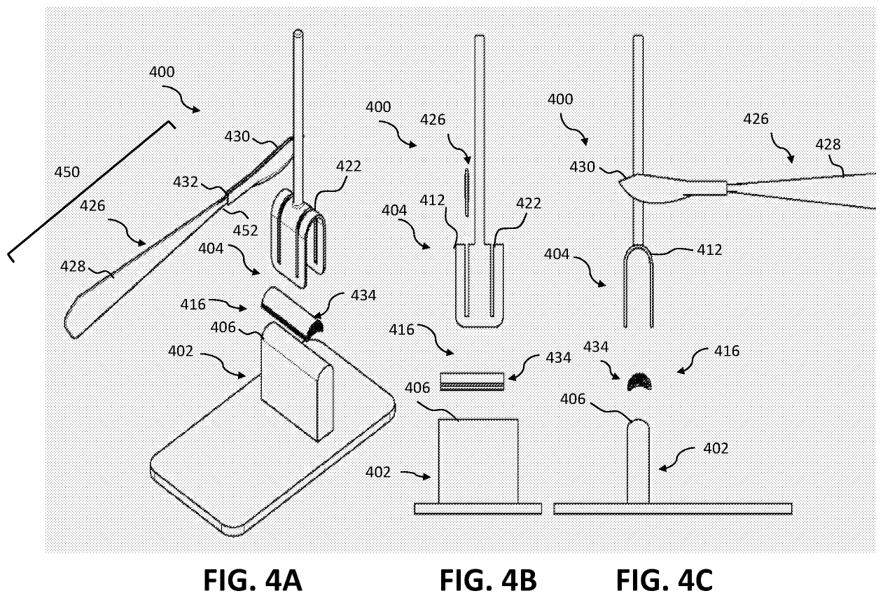

FIG. 4A illustrates an exploded view of a pathology grossing system, according to at least one instance of the present disclosure. FIG. 4B illustrates a side planar view of a pathology grossing system, according to at least one instance of the present disclosure. FIG. 4C illustrates an end view of a pathology grossing tool system, according to at least one instance of the present disclosure. A pathology grossing system 400 can include a pathology grossing tool (as detailed in FIGS. 1-3) which can include an elevated base 402 and a grossing cap 404 along with a knife 426. The knife 426 can be operable to received within the one or more grooves 422 within the grossing cap 404. The knife 426 can be operable to cut through a tissue sample 434 disposed within the membrane receiving area 416. The knife 426 can engage the cutting surface 406 of the elevated base 402. In some instances, the cutting surface 406 can include knife slots therein (shown in FIG. 2).

As can be appreciated in FIGS. 4A and 4C, the cutting surface 406 can be a convex or curved surface allowing increased exposure of the cutting surface 406 to the knife 426 and the grossing cap 404. The convex and/or curved cutting surface 406 can increase the exposure of the cutting surface to the knife 426 while also allowing a rocking and/or pivoting cutting motion within the knife to ensure a crisp cut on the tissue sample. In at least one instance, the convex or surfaced cutting surface 406 can substantially mirror a curved top surface 412 profile of the grossing cap 412, thus providing a substantially uniform sample thickness within the membrane receiving area 416.

The knife 426 can have a handle 428 with a predetermined length 450. The handle 428 can be operable to receive a user's hand and/or forefingers thereon and the predetermined length 450 can be arranged to provide the handle 428 sufficient surface to receive the hand and/or forefingers. In at least one instance, the handle 428 can be shaped and/or contoured to provide an ergonomic surface upon which to receive the user's hand and/or forefingers.

The predetermined length 450 of the handle 428 can vary depending on the desired application, knife usage, and/or user preferences. In some instances, the user can select a handle 428 having a predetermined length 450 according to their desired preference and manner in which the knife 426 is held and/or operated. In other instances, the knife 426 can implement a handle 428 with a predetermined length 450 depending on the procedure being performed, the tissue being worked with, and/or the working environment to operably engage the knife 426 within the pathology grossing system 400.

The knife 426 can include one or more blades 430 disposed at a distal end 452 of the handle 428. The one or more blades 430 can be coupled with the handle 428 via a coupler 432. The coupler 432 can provide engagement between the one or more blades 430 and the handle 428. In at least one instance, the coupler can be a releasable detent pin engagement allowing coupling and decoupling of the one or more blades 430 from the handle 428. The releasable detent pin can have a biasing element coupled therewith to assist in releasing and/or to maintain engagement. In other instances, the coupler 432 can implement a sliding latch arrangement, with or without a biasing element, operable to secure the one or more blade 430 to the handle 428. The coupler 432 can be operable to allow a user to remove, replace, and/or change the one or more blades 430 coupled with the handle 428.

The one or more blades can be coupled and/or decoupled from the knife 426 via actuation of the coupler 432. In at least one instance of the present disclosure, the coupler 432 can be actuable via one-hand operation allowing the one or more blades 430 to be removed from the knife 426 and new blades installed in a single motion. The coupler 432 can provide a biased engagement element allowing a click engagement between the knife 426 and the one or more blades 430. The biased engagement between the one or more blades 430 and the knife 426 via the coupler can include, but is not limited to, a press-fit engagement, tongue and groove arrangement, a detent pin arrangement, corresponding ramped or angled surface engagement, and/or combinations thereof.

The one or more blades 430 can be sized, shaped, and/or implement a cutting edge profile associated with the specific procedure, and thus can be changed and/or replaced depending on the specific procedure. In at least one instance, the one or more blades 430 can vary in length and/or design depending on the desired application. Further, the one or more blades 430 can require replacement overtime due to dulling and/or extended use. In at least one instance, the one or more blades 430 are disposable. In other instances, the one or more blades 430 can be removed, sharpened, and/or recycled.

The grossing cap 404 can secure the tissue sample 434 within the membrane receiving area 416 during preparation of a pathology grossing sample. The grossing cap 404 can be operable to compress and/or secure the tissue same 434 against the cutting surface 406 to prevent movement of the tissue sample 434 within the membrane receiving area 416, thus insuring uniform pathology grossing sample preparation.

As can further be appreciated in FIGS. 4A-4C, the pathology grossing tool can have a base plate 403 coupled within the elevated base 402 to provide stability and working surface to the elevated base 402. The base plate 403 can increase the surface area of the elevated base 402 engaging with a table or other surface to prevent accidental rotation and/or tipping of the elevated base 402 during pathology grossing sample preparation.

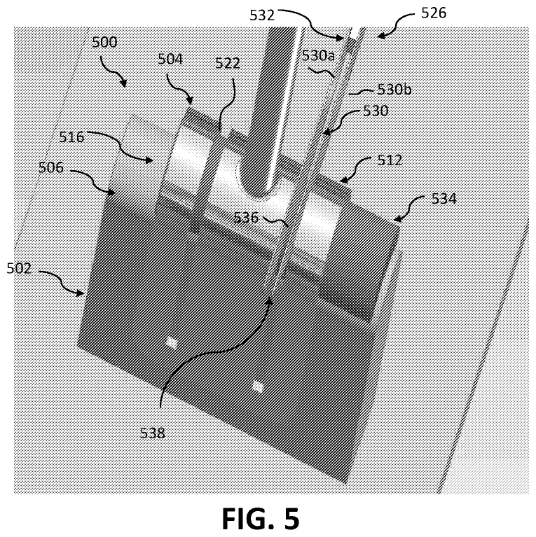

FIG. 5 illustrates an isometric view of a pathology grossing system with a dual blade knife, according to at least one instance of the present disclosure. The pathology grossing tool system 500 can include a tissue sample 534534 secure within the membrane receiving area 516 between a cutting surface 506 of an elevated base 502 and a top surface 512 of a grossing cap 504. The grossing cap 504 can have one or more grooves 522 operable to receive at least a portion of a knife 526 therein. The one or more grooves 522 can expose a portion of the tissue sample 534 within the membrane receiving area 516 allowing one or more blades 530 of the knife 526 to sever pathology grossing sample. The one or more blades 530 can pass through the tissue sample 534 and engage with the cutting surface 506, thereby allowing the knife 526 to separate a pathology grossing sample 536 from the tissue sample 534. The pathology grossing sample 536 can be then be removed from the tissue sample 534 through the groove 522 within the grossing cap 504 while the tissue sample 534 remains secured within the membrane receiving area 516.

As can be appreciated in FIG. 5, the pathology grossing system 500 can implement a knife 526 with two blades 530a, 530b operable to form the pathology grossing sample 536 therebetween. The blades 530a, 530b can have a predetermined spacing 538 and operable to form the pathology grossing sample 536 having a thickness substantially equal to the predetermined spacing 538. The one or more grooves 522 within the grossing cap 504 can have a width exposing a portion of the tissue sample 534 substantially equal to the predetermined spacing 538. In some instances, the one or more grooves 522 can have a width that marginally exceeds the predetermined spacing 538 to prevent pinching and/or deflection of the two blades 530a, 530b inward during sample preparation. In at least one instance of the present disclosure, the predetermined spacing 538 of the blades 530a, 530b can be adjustable depending on the procedure, application, blade cutting profile, and/or user preference.

The knife 526 can implement blade cartridges operable to couple with a knife 526 via coupler 532. The blade cartridge can include two blades (e.g. blades 530a, 530b) and operable to correspond to the predetermined spacing 538 implemented with the grossing cap 504 and then one or more grooves 522. The blade cartridge(s) can be insure the knife 526 implemented with the pathology grossing system 500 implemented the appropriate predetermined spacing 538 for the corresponding one or more grooves, thus providing uniform thickness pathology sample. While FIG. 5 illustrates a knife 526 having two blades (530a, 530b) operably coupled therewith, it is within the scope of the disclosure to implement the knife 526 with more or less blades 530 depending on the procedure, tissue, environment, and/or user preference. Further, the blade cartridge operable to couple with the knife 526 via the coupler 532 can have one or more blades 530. In at least one instance, a knife 526 operable to receive two blades 530a, 530b can accept two cartridges having one blade 530 each. In other instances, the knife 526 operable to receive two blades 530a, 530b can accept a single cartridge having two blades 530. The blade cartridge can be coupled and/or decoupled from the knife 526 via actuation of the coupler 532. In at least one instance of the present disclosure, the coupler 532 can be actuable via one-hand operation allowing the one or more blades 530 to be removed from the knife 526 and new blades installed in a single motion. The coupler 532 can provide a biased engagement element allowing a click engagement between the knife 526 and the one or more blades 530. In at least one instance, the biased engagement element includes one or more angled surfaces operable to engage with a corresponding surface and the biasing element operable to compress and/or example at least one of the angled surfaces and/or the corresponding surfaces, thereby providing a disengagement.

While FIG. 5 illustrates a grossing cap 504 with two grooves 522 formed therein, it is the scope of the present disclosure to implement a grossing cap 504 having any number of grooves formed therein to obtain one or more pathology grossing samples 536 from a tissue sample 534. Further, the one or more grooves 522 formed within the grossing cap 504 can have the same with and/or varying widths depending on the desired pathology grossing sample(s) to be taken from the tissue sample 534. In some instances, a plurality of pathology grossing samples having a uniform thickness from multiple locations within the tissue sample 534 may be desirable. In other instances, a plurality of pathology grossing samples 536 having varying thickness from multiple locations within the tissue sample 534 may be desirable.

As can further be appreciated in FIG. 5, the one or more grooves 522 can be formed within the grossing cap 504 and extend along at least a portion of the sidewalls 514 of the elevated base 502. The extension of the one or more grooves 522 along at least a portion of the sidewalls 514 of the elevated base 502 can allow the grossing cap 504 to be implemented within a variety of thickness of tissue samples 534 within the membrane receiving area 534 as the grossing cap 504 secures the tissue sample between the top surface 512 and the cutting surface 506.

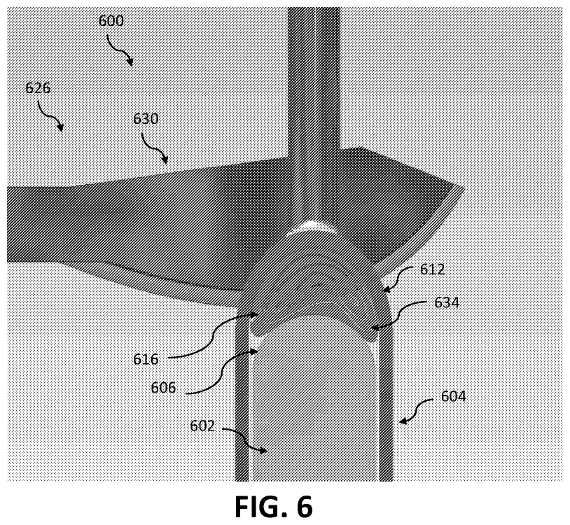

FIG. 6 illustrates an end planar view of a pathology grossing system, according to at least one instance of the present disclosure. The tissue sample 634 within the membrane receiving area 616 can be secured and/or compressed between the top surface 612 of the grossing cap 604 and the cutting surface 606 of the elevated base 602. A knife 626 having one or more blades 630 can be used to pass through the tissue sample 634 and prepare a pathology grossing sample (shown in FIG. 5). The knife 626 engaging the cutting surface 606 after passing through the tissue sample 634 can generate the pathology grossing sample.

As can be appreciated in FIG. 6, the cutting surface 606 can be curved and/or rounded allowing the one or more blades 630 of knife 626 to rock and/or pivot along the cutting surface 606 to cleanly cut the tissue sample 634. While FIG. 6 illustrates the cutting surface 606 having a curved and/or rounded profile, it is within the scope of the present disclosure to implement a cutting surface 606 with a different profile including, but not limited to, substantially flat (as detailed with respect to FIG. 3).

While preferred examples of the present inventive concept have been shown and described herein, it will be obvious to those skilled in the art that such examples are illustrative only. Further, it is within the scope of the present disclosure to combine one or more features of the illustrative examples disclose herein without deviating from the present disclosure. Numerous variations, changes, and substitutions will now occur to those skilled in the art without departing from the disclosure. It should be understood that various alternatives to the examples of the disclosure described herein can be employed in practicing the disclosure. It is intended that the following claims define the scope of the disclosure and that methods and structures within the scope of these claims and their equivalents be covered thereby.

What is claimed is:

1. A pathology grossing tool comprising:
an elevated base having a cutting surface positioned a predetermined height above a bottom surface of the elevated base;
a grossing cap operable to be disposed over at least a portion of the cutting surface, the grossing cap having a sidewalls extending along the predetermined height,
a groove formed in the grossing cap operable to expose the cutting surface;
wherein a membrane receiving area is formed between the cutting surface and the grossing cap when the grossing cap is operably disposed over at least the portion of the cutting surface.

2. The pathology grossing tool of claim 1, wherein the cutting surface has one or more knife slots formed therein.

3. The pathology grossing tool of claim 1, wherein the one or more knife slots are operable to receive at least a portion of a knife blade therein.

4. The pathology grossing tool of claim 1, wherein the one or more knife slots align with the groove.

5. The pathology grossing tool of claim 1, wherein the elevated based includes an alignment block operable to properly align and/or secure the grossing cap.

6. The pathology grossing tool of claim 1, wherein grossing cap has a curved upper surface formed between the sidewalls, wherein the membrane receiving area is formed between the cutting surface and the curved upper surface.

7. The pathology grossing tool of claim 1, wherein the grossing cap has a second groove formed therein.

8. The pathology grossing tool of claim 7, wherein the groove and/or the second groove have a width of at least 4 millimeters (mm).

9. The pathology grossing tool of claim 7, wherein the groove has a first width of at least 4 mm and the second groove has a width of at least 0.5 mm.

10. A pathology grossing system comprising:
a pathology grossing tool having an elevated base and a grossing cap, the pathology grossing tool including:
a cutting surface positioned a predetermined height above a bottom surface of the elevated base;
a groove formed in the grossing cap operable to expose a portion of the cutting surface,
wherein the grossing cap is operable to be disposed over at least a portion of the cutting surface,
wherein a membrane receiving area is formed between the cutting surface and the grossing cap when the grossing cap is operably disposed over at least the portion of the cutting surface; and
a dual-bladed knife operable to be received within the groove, the dual bladed knife having a predetermined spacing between the two blades.

11. The pathology grossing tool of claim 10, wherein the cutting surface has one or more knife slots formed therein, the one or more knife slots operable to receive at least a portion of the dual-bladed knife therein.

12. The pathology grossing tool of claim 11, wherein the one or more knife slots align with the groove.

13. The pathology grossing tool of claim 10, wherein the elevated based includes an alignment block operable to properly align and/or secure the grossing cap.

14. The pathology grossing tool of claim 10, wherein grossing cap has a curved top surface formed between the sidewalls, wherein the membrane receiving area is operably formed between the cutting surface and the curved top surface.

15. The pathology grossing tool of claim 10, wherein the grossing cap has a second groove formed therein.

16. The pathology grossing tool of claim 15, wherein the groove and/or the second groove have a width of at least 4 millimeters (mm).

17. The pathology grossing tool of claim 15, wherein the groove has a first width of at least 4 mm and the second groove has a width of at least 0.5 mm.

18. The pathology grossing tool of claim 15, wherein the dual-bladed knife includes two or more blades operably coupled with a knife handle, and the two or more blades having the predetermined spacing coupled with the knife handle from a blade cartridge.

19. A method of pathology grossing sample, the method comprising:
preparing a tissue sample;
placing the tissue sample on a cutting surface of an elevated base, the elevated base having a predetermined height;
securing the tissue sample on the cutting surface by placing a grossing cap over at least a portion of the cutting surface, wherein the grossing cap has sidewalls extending over a portion of the predetermined height;
cutting the tissue sample through one or more grooves formed in the grossing cap;
removing a pathology grossing sample through the one or more grooves.

20. The method of claim 19, wherein cutting the tissue sample implements a dual-bladed knife having a predetermined spacing corresponding to a width of the one or more grooves.
